(19) United States
(12) Patent Application Publication
(10) Pub. No.: US 2011/0108691 A1
(43) Pub. Date: May 12, 2011

(54) DEVICE FOR THE DISPLAY OF A TAGGING ITEM, SUCH AS IN PARTICULAR AN ADVERTISING LEAFLET, ON A SHELF OF A SELLING SURFACE

(75) Inventors: Manuel Alves, Tortosendo (PT); Pedro Dinis, Tortosendo (PT); Rosa Caseiro, Fundao (PT)

(73) Assignee: JOALPE INDUSTRIA DE EXPOSITORES, S.A., Tortosendo (PT)

(21) Appl. No.: 12/447,970

(22) PCT Filed: Oct. 29, 2007
(86) PCT No.: PCT/EP2007/009353

§ 371 Date: Apr. 30, 2009

(30) Foreign Application Priority Data
Nov. 2, 2006 (FR) 06/09593

(51) Int. Cl. G09F 3/08; B29C 45/00

(52) U.S. Cl. 248/223.41; 264/250

(57) ABSTRACT

The invention relates to a device for the display of a tagging item. The device exhibits the tagging item vertically. The tagging item notably protrudes externally and at a right angle from the front of the shelf. The device exhibits at least one supporting wing containing at its lower end, a mounting element for attachment of the device to the shelf, in particular made of metal. There is a holder for the tagging item. The mounting element is provided in order to cooperate with a drilled shelf whereof the front edge forms a C-shaped rail. The shelf includes a plurality of lower orifices at the lower end of the C-shaped rail. The mounting elements forms into a fastening jumper to the rail exhibiting terminal ends, cooperating with the edges of the C-shaped rail. The link being slaved to the jumper close to its lower terminal end, the locking finger.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC

Not applicable.

### BACKGROUND OF THE INVENTION

1. Field of the Invention

The invention relates to a device for the display of a tagging item, such as in particular an advertising leaflet or the like, on a shelf of a selling surface.

2. Description of Related Art Including Information Disclosed Under 37 CFR 1.97 and 37 CFR 1.98.

In order to draw the consumers' attention to specific items, it is known to arrange a tagging item protruding at right angle, vertically at the front of the shelf.

Such tagging items enable in particular to put in evidence reductions and other promotional operations on certain articles while facilitating the localization of the latter on the shelf.

As known, the tagging item is carried by a display device, generally formed by a plastic supporting wing, designated as “shark wing”, exhibiting on its lower portion a mounting foot for the attachment of the device to the proximal section of the shelf.

This device enables to hold the tagging item, generally by means of a set of tongues and toes cooperating with corresponding orifices of the tagging item.

The lower end of the supporting wing of the display device shows, moreover, a mounting foot for the attachment of the supporting device to the shelf.

The aim of the present invention is to provide a display device whereof the mounting foot may be fixed to a drilled shelf whereof the front edge is a C-shaped rail, said shelf exhibiting lower orifices at the lower end of the rail, enabling solid attachment of the device to the shelf without protruding over the useful supporting surface area of the latter.

Another aim of the present invention is to provide a device for the display of a tagging item, in particular single-piece and at a lesser cost.

Other aims and advantages of the invention will appear in the following description which is given solely for illustrative purposes and without being limited thereto.

### BRIEF SUMMARY OF THE INVENTION

The invention relates to a device for the display of a tagging item, such as in particular an advertising leaflet or the like, on a shelf of a selling surface, the device being provided for exhibiting the tagging item vertically, the latter protruding notably externally and at right angle from the front of the shelf. The device exhibits at least one supporting wing comprising at its lower end, mounting means for the attachment of the device to said shelf, in particular made of metal, said supporting wing exhibits means for holding the tagging item, in particular by one of its edges.

According to the invention, said mounting means are provided in order to cooperate with a drilled shelf whereof the front edge is a C-shaped rail, said shelf exhibiting moreover lower orifices at the lower end of the C-shaped rail, and in that said mounting means are conformed into a fastening jumper to the rail exhibiting two terminal ends capable of cooperating with the edges of said C-shaped rail. The mounting means exhibit, moreover, a locking finger protruding from the jumper via a link being slaved to said jumper close to its lower terminal end, said locking finger being intended for engaging into one of the corresponding lower orifices of the shelf.

### BRIEF DESCRIPTION OF THE SEVERAL VIEWS OF THE DRAWINGS

The invention will be understood better when reading the following description accompanied by the appended drawings.

FIG. 1 is a side sectional view of a device for the display of a tagging item according to an embodiment of the invention.

FIG. 2 is a side sectional view of the device as illustrated on FIG. 1 pivoting around the upper edge of the rail of the shelf.

FIG. 3 is a detailed perspective view of the front edge of the shelf and of the, de-coupled, mounting means of the device as illustrated on FIG. 1.

FIG. 4 is a perspective view of the mounting means of the device as illustrated on FIG. 1 meshed into the front edge of the shelf.

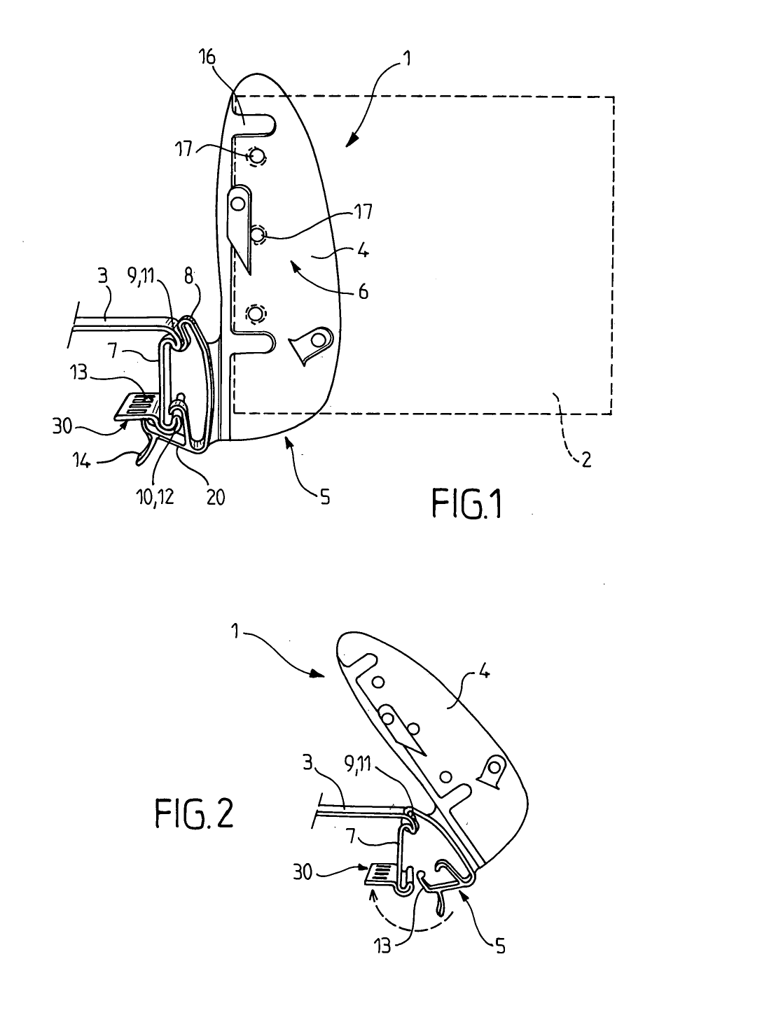

### DETAILED DESCRIPTION OF THE INVENTION

The invention relates to a device 1 for the display of a tagging item 2, such as in particular an advertising leaflet or the like, on a shelf 3 of a selling surface.

The device 1 is provided for exhibiting the tagging item 3 vertically, the latter protruding notably externally and at right angle from the front of the shelf 3.

The device exhibits at least one supporting wing 4 whereof the lower end includes mounting means 5 for the attachment of the device to said shelf, in particular made of metal.

The supporting wing 4 exhibits means 6 for holding the tagging item, in particular by one of its edges.

According to the invention, the mounting means 5 are provided in order to cooperate with a drilled shelf whereof the front edge is a C-shaped rail 7. Said shelf exhibits, moreover, lower orifices 30 at the lower end of said C-shaped rail. This shelf is made in particular from of a metallic sheet after cutting and forming/folding operations.

The mounting means are conformed into a fastening jumper 8 to the rail exhibiting two terminal ends 9, 10 capable of cooperating with the edges 11, 12 of said C-shaped rail. Said mounting means 5 exhibit, moreover, a locking finger 13 protruding from the jumper 8 via an elastic link 20 being slaved to said jumper 8 close to its lower terminal end 10. The locking finger 13 is intended for engaging into one of the corresponding, in particular rectangular, lower orifices 30 of the shelf.

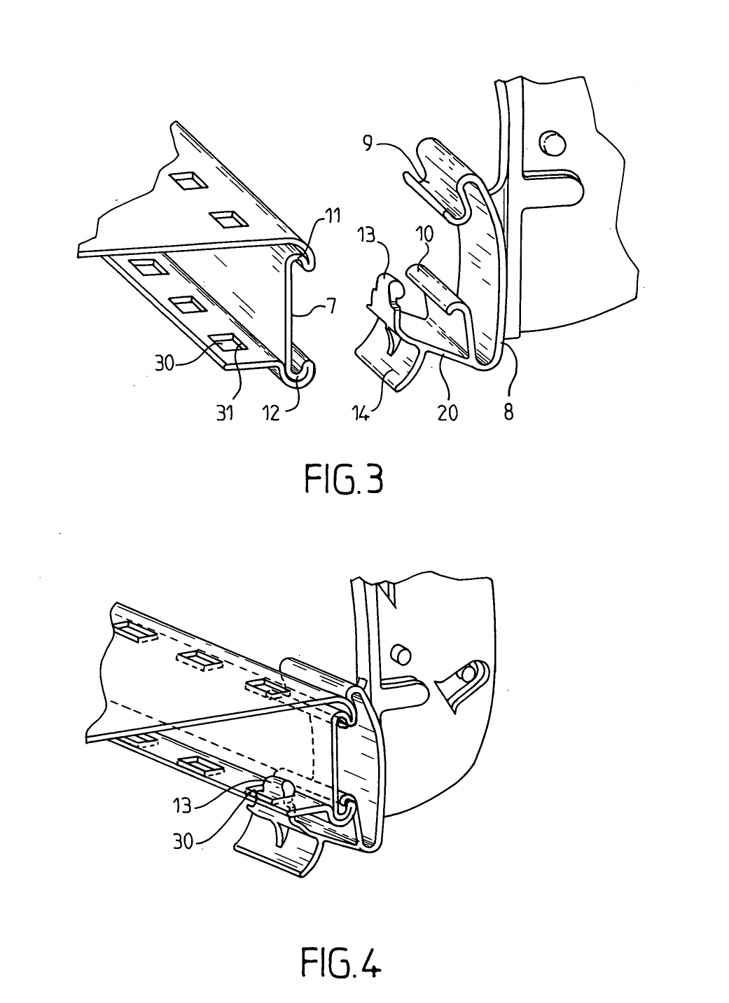

As illustrated, the fastening jumper may be conformed into a 6 profile, the terminal ends 9, 10 cooperating with the edges, in particular bent of the C-shaped rail. As illustrated on FIGS. 3 and 4, the locking finger 13 is intended for hooking into the front ridge 31 of one of the lower orifices 30.

A release element 14 may be provided. This release element protrudes towards the bottom of the locking finger 13 and cooperates with said elastic link for engaging or disengaging the locking finger 13 in case of manual action on said releaser 14.

Advantageously, as illustrated on FIG. 2, the device is placed by a pivoting movement of the jumper around the upper edge of the C-shaped rail, in particular combined with manual action on the releaser 14 for the placement of the locking finger 13 in one of the orifices 30. In this view, the upper terminal end 9 of the fastening jumper 7 may be substantially bent thus forming a dummy articulation with the upper edge the upper edge 11 of said C-shaped rail.

The means 6 for holding the tagging item might be formed, in particular of a set of tongues 16 extending parallel to the plane of the supporting wing 4 to define at least one insertion space for the tagging item. Said at least one insertion space is run through by toes 17 of the device capable of engaging with corresponding orifices of the tagging item.

Advantageously, but not necessarily, the device can be made of plastic material, as a single-piece. The invention also relates to a manufacturing method of such a tagging item wherein the device is made of plastic material and obtained by injection-molding techniques.

Naturally, other embodiments, understandable to the man of the art, could have been contemplated without departing from the framework of the invention defined by the claims below.

1. A device for display of a tagging item on a shelf of a selling surface, said device exhibiting the tagging item vertically, the tagging item protruding notably externally and at a right angle from a front of the shelf, said device comprising:
at least one supporting wing having a lower end and being comprised of:
mounting means for attachment the shelf, being comprised of metal, and, being positioned on said lower end of the supporting wing; and
means for holding the tagging item, said mounting means being cooperative with a drilled shelf, having a front edge to form a C-shaped rail with lower orifices at a lower end thereof, said mounting means being conformed into a fastening jumper to the rail exhibiting two terminal ends cooperating with edges of said C-shaped rail, said mounting means having a locking finger protruding from the jumper via an elastic link, said elastic link being slaved to said jumper close to a lower terminal end, said locking finger engaging into one of the corresponding lower orifices of the shelf.

2. A device according to claim 1, wherein the locking finger hooks into a front ridge of one of the orifices.

3. A device according to claim 1, wherein the fastening jumper is Ω profiled.

4. A device according to claim 1, wherein a release element protrudes towards the bottom of the locking finger, being cooperative with the elastic link for engaging into or disengaging from the locking finger in case of manual action thereon.

5. A device according to claim 1, wherein the upper terminal end of the fastening jumper is substantially bent, forming a dummy articulation with the upper edge of the C-shaped rail so as to enable placement of the mounting means by a pivoting movement.

6. A device according to claim 1, wherein the means for holding the tagging item comprises:
a set of tongues extending parallel to the plane of the supporting wing to delineate at least one insertion space for the tagging item, said at least one insertion space being run through by toes, said toes engaging into corresponding orifices of the tagging item.

7. A device according to claim 1, being comprised of plastic material, and in a single-piece.

8. A method for making a device for the display of a tagging item according to claim 1, the method comprising the steps of:
forming the device as comprised of plastic material and obtained by injection-molding techniques.
